(19) United States
(12) Patent Application Publication
(10) Pub. No.: US 2016/0258318 A1
(43) Pub. Date: Sep. 8, 2016

(54) TURBINE ENGINE WASHING SYSTEM

(71) Applicant: Hydro Engineering Equipment and Supply Co., LLP, Salt Lake City, UT (US)

(72) Inventor: James P. McCormick, Sandy, UT (US)

(73) Assignee: Hydro Engineering Equipment and Supply Co., LLP, Salt Lake City, UT (US)

(21) Appl. No.: 14/635,502

(22) Filed: Mar. 2, 2015

(51) Int. Cl. F01D 25/00; B08B 9/00

(52) U.S. Cl. CPC F01D 25/002; B08B 9/00

(57) ABSTRACT

Portable aircraft turbine engine washing systems and methods are provided. One such washing system has a portable base unit, a wash line connectable to the portable base unit and configured to be connected to an aircraft turbine engine or a fluid delivery cleaning device, and a water tank movable with the portable base unit and can hold water. A water pump apparatus is movable with the portable base unit and can pump water out of the water tank and into the wash line. A solution tank is movable with the portable base unit and can hold a solution. A solution pump apparatus is also movable with the portable base unit and can pump solution from the solution tank into fluid communication with the wash line. A controller apparatus adjustably controls a dilution ratio of the solution with water while the solution and water are pumped into the wash line.

### TECHNICAL FIELD

The present disclosure relates generally to washing systems for aircraft turbine engines and specifically to a portable washing system configured to use water from a single storage tank to wash and rinse a gas path of a turbine engine.

### BACKGROUND

Jet engines and turbine engines typically include turbine blades that are specially designed to maintain cooler temperatures in the blades. The turbine blades typically include channels formed therein through which fresh air is driven to cool the turbine blades. The fresh air flows through outlet holes on the turbine blades out into the hot gas flow surrounding the turbine blades. The relatively cool fresh air helps counterbalance the super high exhaust temperatures that the turbine blades are exposed to thereby protecting the blades from melting. As the engines operate, deposits begin to accumulate on the tips of the turbine blades in the area of the outlet holes of the fresh air channels. The deposits can sometimes occlude the air outlet holes, which results in hot spots forming on the tips of the turbine blades. Sometimes these hot spots develop into melted material and may even result in chunks of the blade dislodging, thus throwing the turbine out of balance. Further, as the deposits build up on the turbine blades, the aerodynamics of the turbine blades are modified, thus reducing the efficiency of the engine. As the efficiency goes down, the engine begins running hotter at a specific power output level.

Engine efficiency is also a key concern of aircraft operators, especially for turbine-powered rotary wing aircraft. At high altitudes, engine power is reduced because of reduced oxygen and engines must run at high power levels to maintain flight or a desired speed while in flight. Over time, this causes undue strain on engine parts and results in costly maintenance, repairs, and fuel charges. As the engine is used, fuel, saltwater, and other fluids and debris entering the gas path build up deposits on surfaces of the blades and other parts, and the engine's efficiency is reduced. In many cases, the efficiency may drop by an additional 2 to 5 percent which may be recovered by cleaning. This drop in efficiency, when added to other efficiency losses such as those experienced at altitude, puts an enormous strain on the engine and can limit the ability of the engine to provide the power needed to keep the aircraft in flight and may further expensively burn limited fuel reserves of the aircraft, leading to reduced flight ranges and other undesirable effects.

Accordingly, aircraft turbine engines are regularly cleaned in order to counteract or prevent corrosion and/or buildup of efficiency-reducing deposits in the gas path. Commonly, the engines are cleaned by washing apparatus that has a large tank of water within which turbine gas path deposit removing solvents (e.g., soaps or detergents) and antifreeze elements are diluted. This pre-mixed wash fluid is pumped into the gas paths of the engine, then the engine is spooled (spun at low rpm) while the wash fluid soaks the blades and other surfaces. The washing apparatus then rinses the wash fluid from the gas path using rinse fluid pumped from a separate pre-mixed tank (i.e., a rinse tank) that does not include turbine deposit dissolving agents. The internal deposits of the turbine engine are thereby removed and rinsed away, and the engine's efficiency is improved.

However, the washing apparatuses commonly used to clean these turbine engines are not well suited for many applications. The tanks of wash and rinse fluids are usually bulky and are therefore difficult to store and transport. This means that in busy aircraft hangars, the washing apparatuses take up precious, limited space. Multiple kinds of pre-mixed fluids must be mixed and stored for these apparatuses as well. In locations with lesser needs, such as a medical or news helicopter pad, space, personnel, and equipment availability may be even more limited.

There is therefore a need for improvements in turbine engine wash systems.

### SUMMARY

One aspect of the present disclosure relates to a portable aircraft turbine engine washing system. The system may comprise a portable base unit and a wash line connectable to the portable base unit that is configured to be connected to an aircraft turbine engine or a fluid delivery device capable of cleaning an aircraft turbine engine. A water tank may be movable with the portable base unit and configured to hold water, and a water pump apparatus may be movable with the portable base unit and configured to pump water out of the water tank and into the wash line. A solution tank may be movable with the portable base unit and configured to hold a solution, and a solution pump apparatus may be movable with the portable base unit and configured to pump solution from the solution tank into fluid communication with the wash line. The washing system may further include a controller apparatus configured to adjustably control a dilution ratio of the solution pumped by the solution pump apparatus with water pumped into the wash line from the water tank while the solution and water are pumped into the wash line.

Some embodiments of the washing system further comprise an alcohol solution held in the solution tank and/or a turbine deposit dissolving agent held in the solution tank. The system may include a mixing vessel in fluid communication with the wash line, wherein the mixing vessel comprises a chamber configured to receive and mix output of the water tank and output of the solution tank.

The solution pump apparatus may be a peristaltic pump. The portable base unit may comprise a wheeled cart. The portable base unit may have a height of about 5 feet or less. The portable base unit may have a width of about 3 feet or less. The water tank may have a capacity of about 20 gallons or less.

In some arrangements, water output from the water pump apparatus may be configurable to flow in the wash line independent of solution output from the solution pump apparatus. The controller apparatus may be configurable to control the dilution ratio of the solution pumped by the solution pump apparatus into the wash line to a zero value. The wash line may be configured to be connected to a gas path of the aircraft turbine engine.

An electrical energy storage device may also be included in the system, wherein the water pump apparatus and the solution pump apparatus are electrically powered by the energy storage device.

In another aspect of the disclosure, a portable aircraft turbine engine washing system is disclosed that comprises a portable base unit and a wash line connectable to the portable base unit and configured to be connected to an aircraft turbine engine or a fluid delivery device capable of cleaning an aircraft turbine engine. A water tank may be movable with the portable base unit and configured to hold water, and a water pump apparatus may be movable with the portable base unit and configured to pump water out of the water tank and into the wash line. A solution tank may be movable with the portable base unit and configured to hold a solution, and a solution pump apparatus may be movable with the portable base unit and configured to pump solution from the solution tank into fluid communication with the wash line. A component tank may be movable with the portable base unit and configured to hold a fluid component to be provided to the aircraft turbine engine, and a component pump apparatus may be configured to pump the fluid component from the component tank into fluid communication with the wash line. The system may also include a controller apparatus that may be configured to adjustably control a solution dilution ratio of the solution pumped by the solution pump apparatus into fluid communication with the wash line while water is pumped into the wash line from the water tank, and the controller apparatus being configured to adjustably control a component dilution ratio of the fluid component pumped by the component pump apparatus into fluid communication with the wash line while water is pumped into the wash line from the water tank.

In some embodiments, the system may further comprise the fluid component and the solution, wherein the fluid component is an alcohol solution and the solution is a turbine engine deposit cleaning agent. The component pump apparatus and the solution pump apparatus may be configured to provide fluid component and solution into the wash line simultaneously. The system may also include a mixing vessel in fluid communication with the wash line, wherein the mixing vessel comprises a chamber configured to receive and mix water output from the water tank, solution output from the solution tank, and fluid component output from the component tank. A first mixing vessel and a second mixing vessel may be included, wherein the first and second mixing vessels may be in fluid communication with the wash line, and wherein the first mixing vessel comprises a first chamber configured to receive and mix water output from the water tank and solution output from the solution tank. The second mixing vessel may comprise a second chamber configured to receive and mix water output from the water tank and fluid component output from the component tank.

In another aspect of the disclosure, a method of washing an aircraft turbine engine is provided. The method may comprise positioning a portable wash system proximate an aircraft turbine engine, with the portable wash system having a first tank holding a first fluid and a second tank holding a second fluid. The portable wash system may be connected to the aircraft turbine engine or to a fluid delivery device capable of cleaning an aircraft turbine engine using a wash line. The aircraft turbine engine may be washed by pumping the first fluid from the first tank through the wash line while pumping the second fluid from the second tank into the wash line. The aircraft turbine engine may be rinsed by pumping the first fluid from the first tank through the wash line without pumping a second fluid from the second tank into the wash line.

A gas path of the aircraft turbine engine may be washed or rinsed using the first and second fluids. The first and second fluids may be mixed before pumping into the wash line for washing the aircraft turbine engine. The portable wash system may be provided with a third tank holding a third fluid. The third fluid may be pumped from the third tank through the wash line while washing the aircraft turbine engine. The third fluid may be pumped from the third tank through the wash line while rinsing the aircraft turbine engine.

The method may further comprise controlling a dilution ratio of the second fluid relative to the first fluid while washing the aircraft turbine engine. The pressure in the wash line may be controlled automatically using a pressure regulator. The second fluid may be used to inhibit freezing of the first fluid when pumped through the wash line, and/or the second fluid may facilitate removal of impurities in the aircraft turbine engine when provided to the aircraft turbine engine.

The above summary of the present invention is not intended to describe each embodiment or every implementation of the present invention. The Figures and the detailed description that follow more particularly exemplify a preferred embodiment.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIGS. 1A through 1C are various views of a wash system of the present disclosure with a wheeled leg extended.

FIGS. 1D through 1F are various view of the wash system of FIGS. 1A-1C with the wheeled leg retracted.

FIG. 2 is a cutaway isometric view of the front of the wash system of FIGS. 1A-1F.

FIGS. 3A-3C are views of a base unit of a wash system of the present disclosure.

FIG. 4 is an exploded view of flow systems through a base unit of a wash system of the present disclosure.

FIG. 5 is an electrical diagram of electrical components of a base unit of the present disclosure.

FIG. 6 illustrates an example embodiment of a wash system that is connected to an aircraft by a wash line.

FIG. 7 is a flowchart illustrating a method of the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure is directed to systems and methods for cleaning turbine engines. In one embodiment, a portable aircraft turbine engine washing system is set forth that has a portable base unit, a wash line connectable to the portable base unit and configured to be connected to an aircraft turbine engine or a fluid delivery device capable of cleaning an aircraft turbine engine, a water tank that is movable with the portable base unit and configured to hold water, and a water pump apparatus that is configured to pump water into the wash line. A second tank that is movable with the base unit may be configured to hold concentrated solution, and a pump apparatus for the solution may be used to pump solution from the solution tank into fluid communication with the wash line. A controller apparatus may be used to adjustably control a dilution ratio of the solution pumped by the solution pump with the water pumped into the wash line. Water pumped into the wash line may be pumped without solution (e.g., for rinsing steps of a cleaning process) or may be pumped with diluted solution (e.g., for washing steps). Thus, a wash or rinse fluid may be mixed on-demand by a portable unit using this washing system, thereby reducing the need for separate pre-mixed wash and rinse tanks in the washing system. This may dramatically reduce the size, weight, and cost of the wash system as well.

The concentrated solution may be a detergent or soap-like chemical composition for cleaning and removing deposits from a gas path of an aircraft turbine engine. The solution may also or alternatively be an antifreeze agent such as isopropyl alcohol used to prevent freezing of water from the water tank in the tank, wash line, or turbine. The alcohol may also improve the cleaning of certain substances in an engine. The water used may be a supply of clean soft water, purified water, or distilled water. The solution and water may be mixed in a mixing chamber in the washing apparatus or may be mixed as they are both fed into flow in the wash line at separate points along the fluid path through the wash system.

The washing system may be a portable cart with wheels and/or a wheeled leg to ease transportation of the unit. The size of the cart may be constructed to be small enough to fit through a doorway (e.g., a normal doorway that would be used for a person to access a hangar or storage room) and next to or underneath an aircraft to access and connect to the turbine engines. Thus, in some embodiments the base unit may have a height of about 5 feet or less, and the unit may have a width of about 3 feet or less.

The overall capacity of the water tank may be about 20 gallons or less, which may correspond to the amount of water necessary to perform about two washing and rinsing cycles on typically-sized turbine engines. For example, in an exemplary embodiment of a system shown in the figures, a large aircraft served by the system may need to receive a rate of about 2.5 gallons of fluid per minute for proper washing and rinsing. A typical wash cycle may take about 60 seconds, and a typical rinse cycle may take about 120 seconds, so about 7.5 gallons of fluid may be used overall for a single turbine engine cleaning cycle. After completion of a single turbine engine cleaning cycle, the aircraft operator may check the efficiency of the engine that was washed. If the efficiency is still below a target efficiency, the entire wash cycle may be completed a second time. Thus, having about 20 gallons of storage in the washing system may be beneficial to ensure that two complete cycles of cleaning can be conducted without needing to refill the water tank between cycles (and with a relatively small amount of excess water available if needed). The supply of charge from a battery in the wash system and the supply of cleaning solution and/or antifreeze solution may also be designed to be able to complete multiple wash cycles without needing to refill or recharge in between.

The portability and compactness of the system may be enhanced by the use of a battery-based power source for the washing system, since using a battery system may eliminate a need to store fuels (e.g., for fuel cells or generator-based systems), both internal to and external to the system. The battery or batteries may be used to power the pumps and control system. One or more of the pumps may be peristaltic pumps that inject solution or water into the wash line.

In another aspect of the disclosure, a washing system may have a water tank, a solution tank, and a component tank. The component tank may be a third tank used to store an additional component that may be pumped into the wash line. For example, the solution tank may store a supply of a turbine engine deposit cleaning agent and the component tank may be used to store a supply of an alcohol solution that can also be pumped into the wash line. The media stored in the solution tank and the component tank may be provided into the wash line individually or separately, and they may be provided to the wash line at different rates, at different times, or both.

Another aspect of the disclosure relates to a method of washing a turbine engine of an aircraft, which method may include positioning a portable wash system near to the aircraft turbine engine, connecting the wash system to the turbine engine or a fluid delivery device capable of cleaning the turbine engine using a wash line, then washing the engine by pumping a first fluid from a first tank in the system through the wash line while pumping a second fluid from a second tank of the system into the wash line. The engine may thereafter be rinsed by pumping the first fluid from the first tank through the wash line without pumping the second fluid into the wash line. In an example implementation of this method, the first fluid may be water and/or an antifreeze agent (e.g., isopropyl alcohol) and the second fluid may be a detergent or other deposit-dissolving agent that may be added and diluted into the first fluid. The first and second fluids may in some cases be pumped along with a third fluid, such as a supply of alcohol or water that is not included in the first and second fluids.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

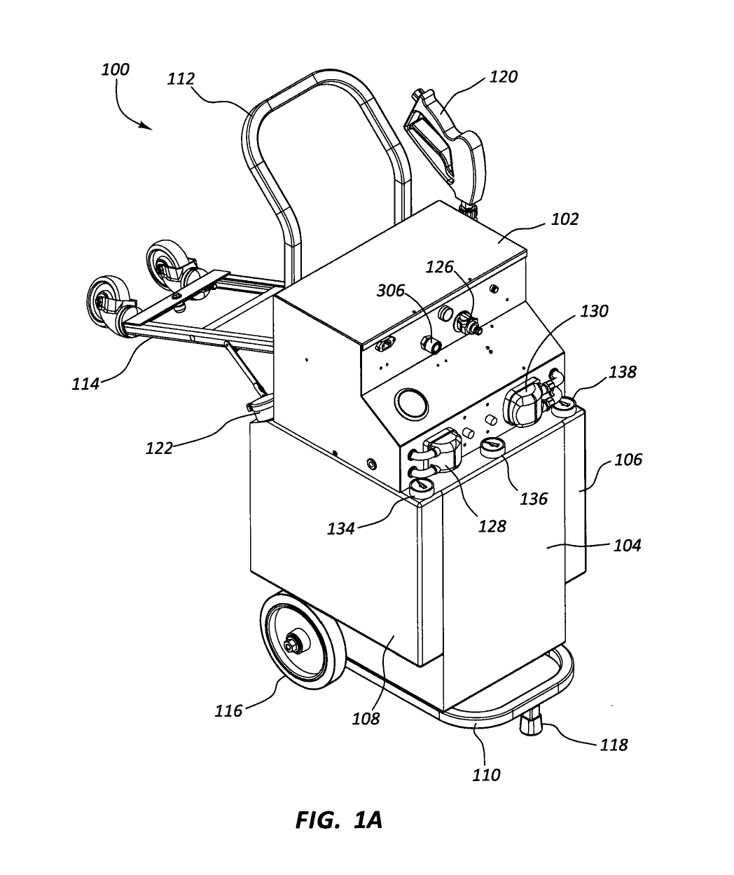

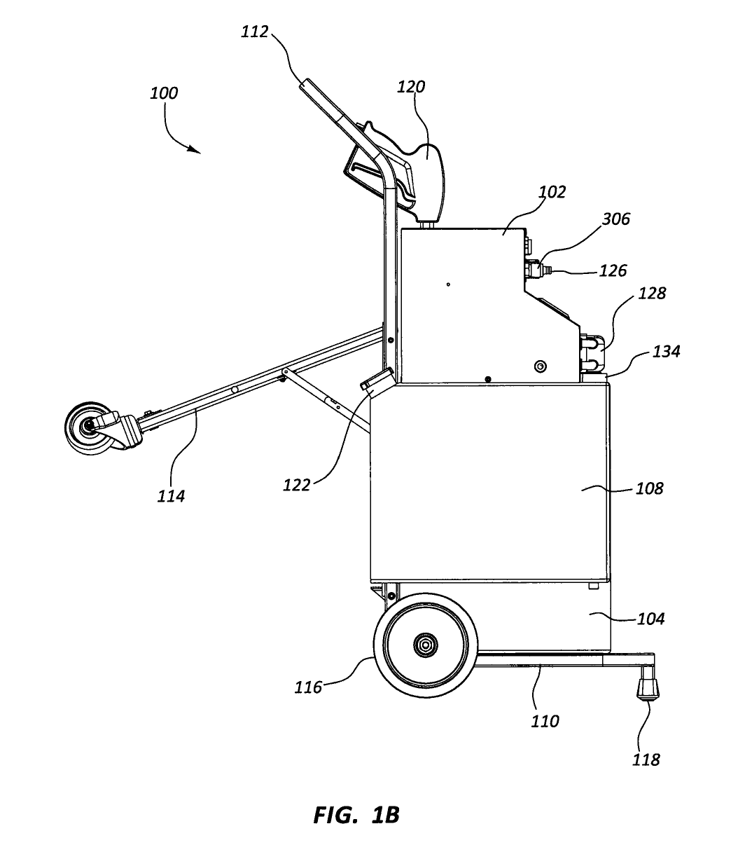

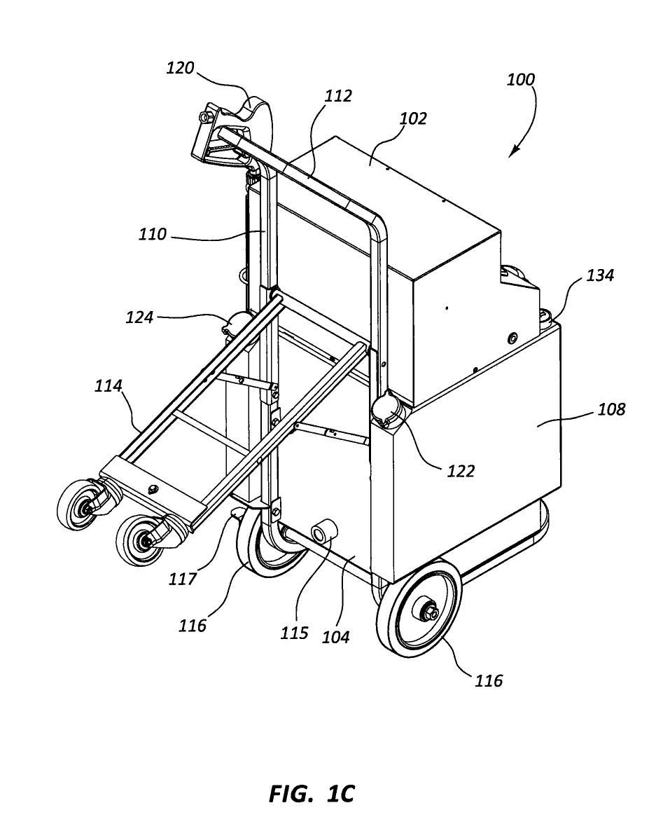

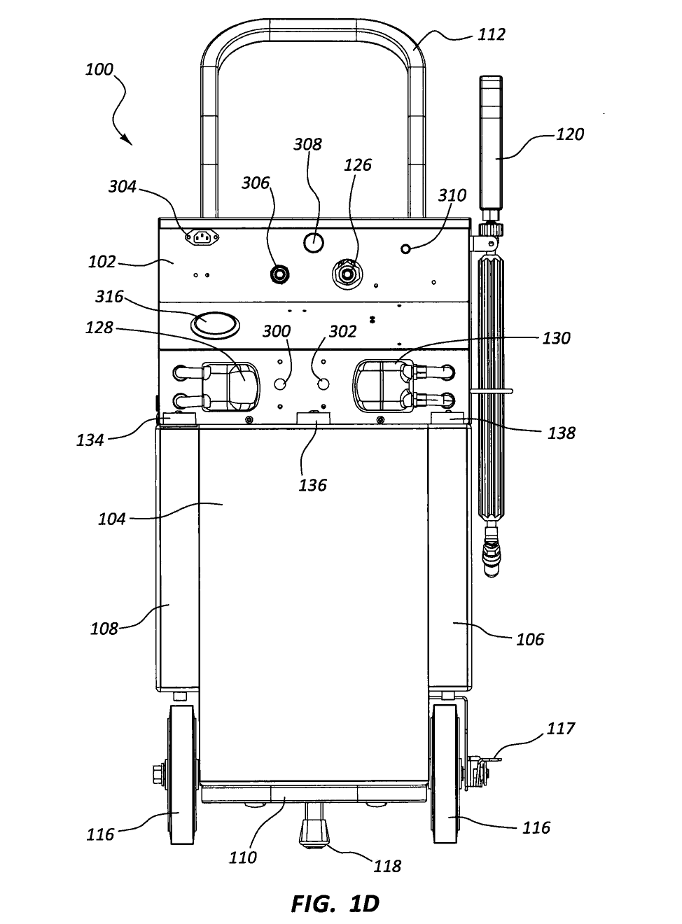

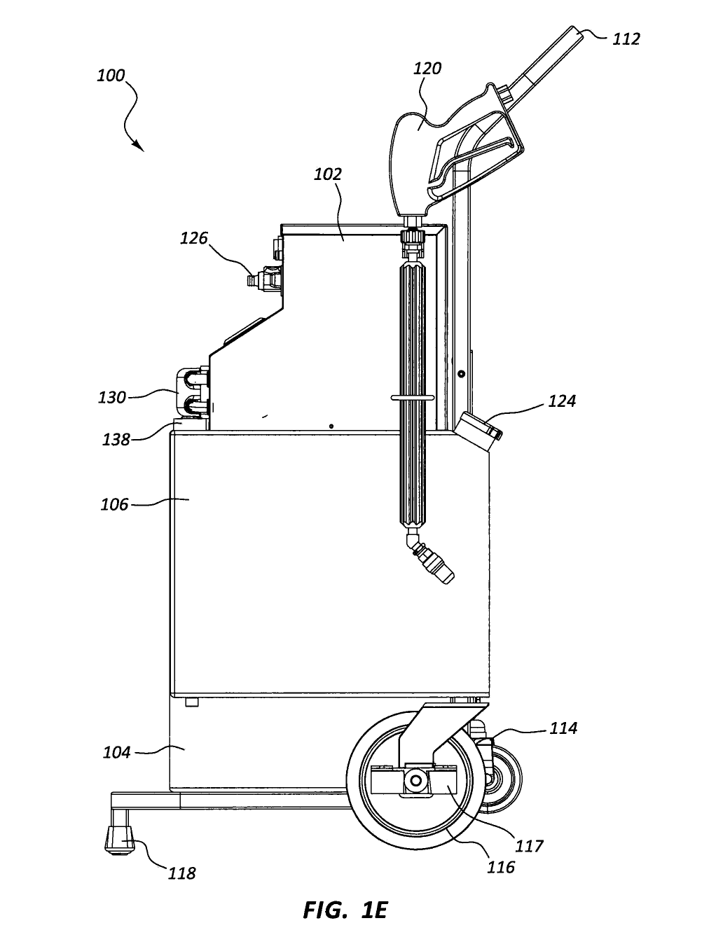

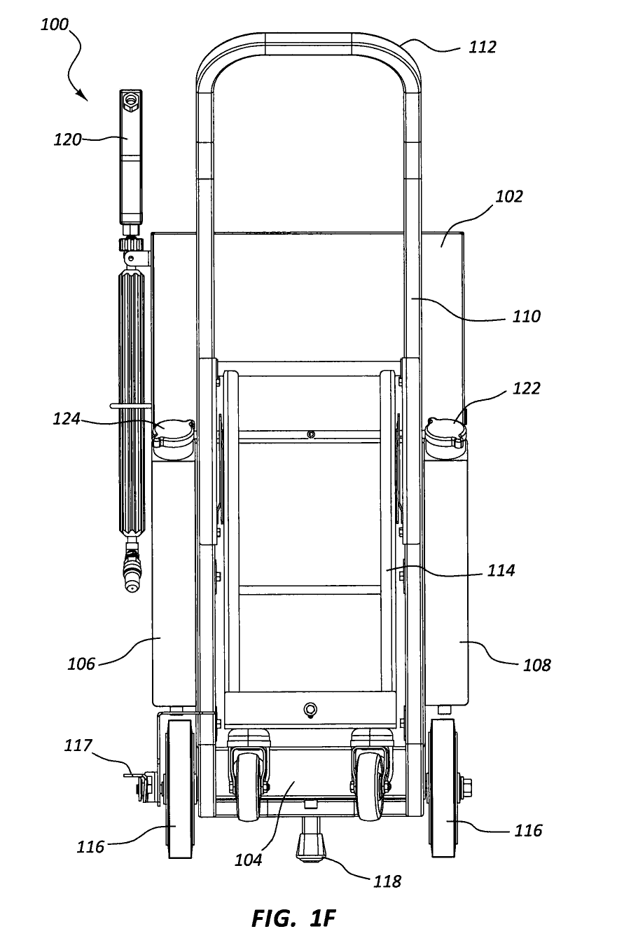

Referring now to FIGS. 1A-1F, exterior elements of a wash system 100 are shown. The wash system 100 may comprise a control unit 102 and tanks 104, 106, 108 attached to a frame 110. The frame 110 may extend underneath and around a rear side of the the tanks 104, 106, 108 to form a handle 112 that extends rearwardly away from the control unit 102 at an angle. See FIGS. 1B, 1E. FIG. 1A is a front isometric view, FIG. 1B is a right side view, FIG. 1C is a rear isometric view, FIG. 1D is a front view, FIG. 1E is a left side view, and FIG. 1F is a rear view of the system 100.

In FIGS. 1A-1C, a wheeled leg 114 is folded into an extended position relative to the frame 110, and FIGS. 1E-1F show the system 100 with the wheeled leg 114 folded into a storage or retracted position, with its final position being shown in FIG. 1F. When retracted, the wheeled leg 114 may rest against a leg support 115. See FIG. 1C.

The frame 110 may be portable and movable on large wheels 116 when tilted rearward at the handle 112. The system 100 may be held at rest on a frontally located foot 118 along with the wheels 116, or may be rested on the wheels of the wheeled leg 114 along with the large wheels 116 on the frame 110. Thus, the frame 110 may function like a dolly or hand truck for moving the control unit 102 and tanks 104, 106, 108. In some embodiments, the frame 110, wheels 116, foot 118 and control unit 102 may collectively be referred to as a “base unit.” The tanks 104, 106, 108 may be carried by the frame 110 or carried with the collective base unit. The wheels 116 may be connected to a braking system 117 to secure the cart when it is in a desired position. The braking system 117 may be a rotatable, foot-operated lever configured to keep at least one of the wheels 116 from moving while the braking system 117 is engaged.

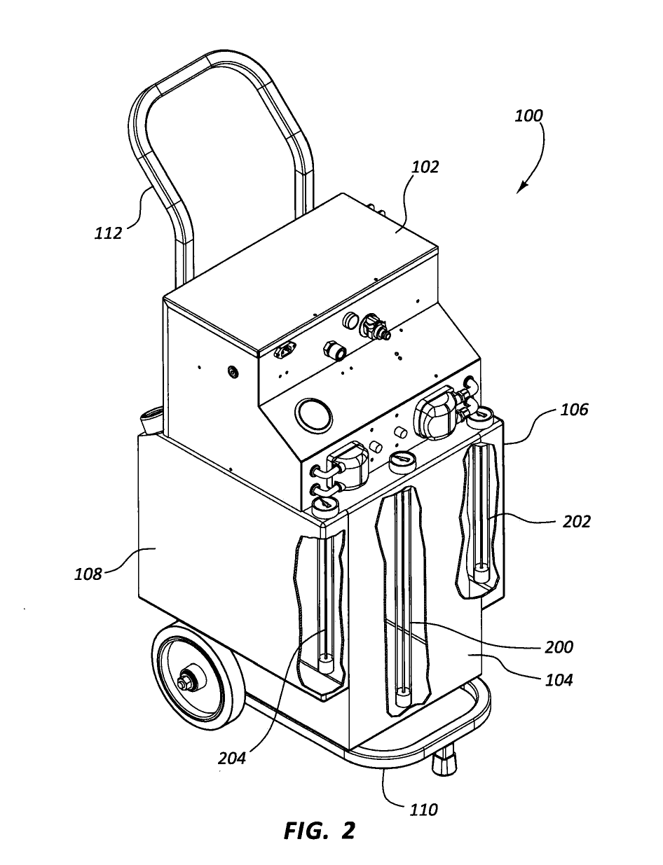

The system 100 may also comprise a sprayer gun 120 that is selectively attachable or detachable from the control unit 102. Compare FIG. 2, which shows the system 100 without the sprayer 120. The hoses and other connective equipment for linking the system 100 to an aircraft turbine engine are not shown in FIGS. 1A-1F and 2. The sprayer gun 120 may comprise an elongated wand extending from its handle, and the elongated wand may comprise an adjustable nozzle at its end opposite the handle. The sprayer gun 120 may therefore be referred to as a wash wand and nozzle, and may be used to spray fluid into an engine. In other embodiments, a washing probe device may be attached to the end of a wash line connected to the system 100, and the washing probe device may be inserted into the aircraft turbine engine for cleaning purposes to deliver the washing and rinsing fluids from the system 100. The sprayer gun 120 or washing probe device may be referred to as fluid delivery devices capable of cleaning an aircraft turbine engine.

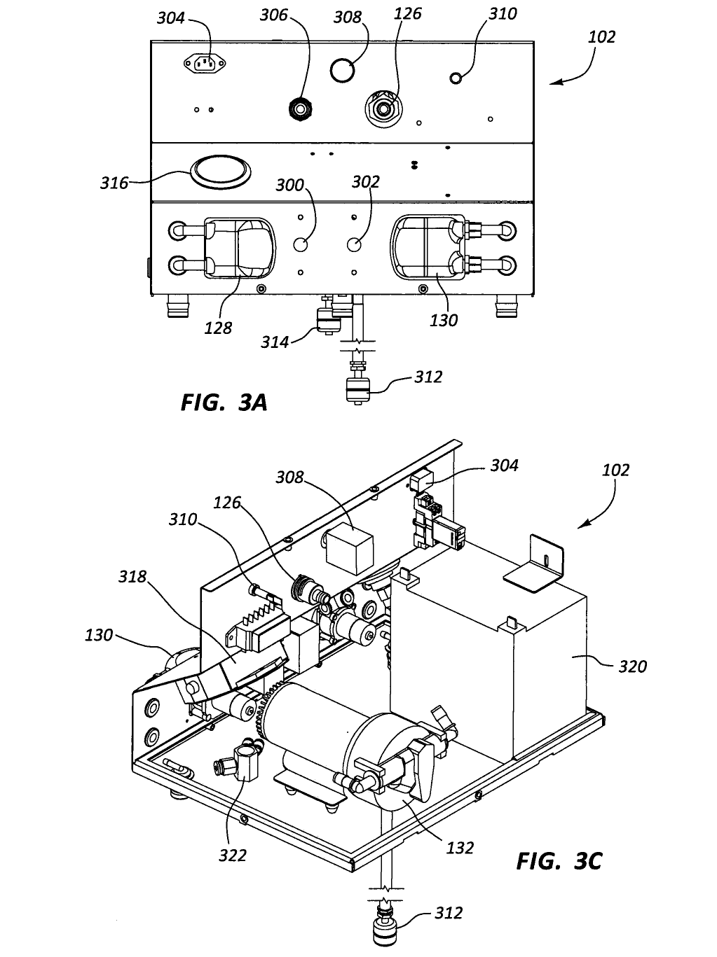

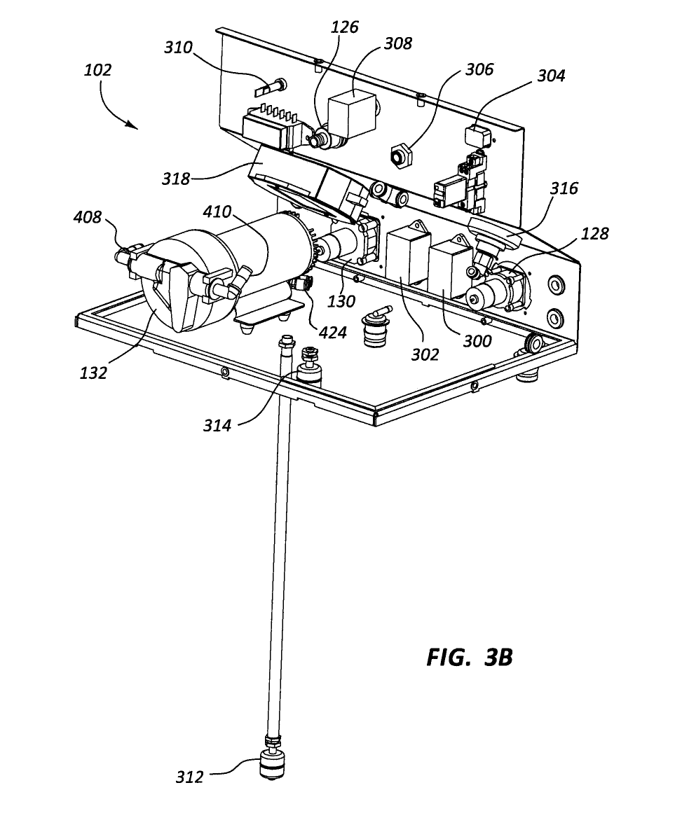

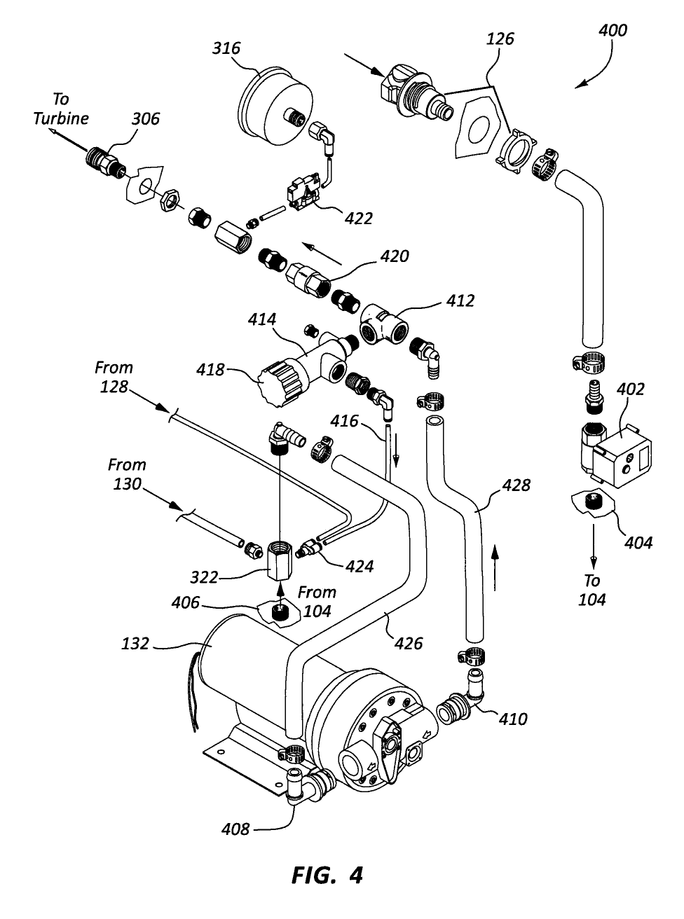

Referring again to FIGS. 1A-1F, the tanks 104, 106, 108 may be filled via external openings or inlets. A right inlet 122 may open into the right tank 108 and a left inlet 124 may open into the left tank 106. A central coupler 126 may be used as an inlet that opens into the central tank 104. See also FIGS. 3A, 3B, and 4.

The central tank 104 may be configured as a water tank to hold a supply of water. The central tank 104 may have a capacity of about 20 gallons for a typical wash-rinse cycle of a turbine engine, but a smaller or larger capacity may be implemented in order to service smaller or larger engines (or smaller/larger numbers of engines), respectively. The left and right tanks 106, 108 may be configured to store a supply of concentrated or undiluted washing fluid and/or antifreeze fluids. Each of the left and right tanks 106, 108 may contain a different composition or type of fluids, or each may contain the same fluids. For example, the left tank 106 may contain a supply of turbine engine deposit dissolving solution and the right tank 108 may contain a supply of isopropyl alcohol. Alternatively, the left tank 106 may contain a first concentration of one type of solution and the right tank 108 may contain a second concentration of the same type of solution. Thus, different concentrations or chemical compositions may be created when the contents of each tank 106, 108 is respectively or simultaneously pumped into a wash line and into an aircraft engine.

A right pump 128 may be associated with the right tank 108 and a left pump 130 may be associated with the left tank 106. The right and left pumps 128, 130 may be peristaltic pumps that are configurable to pump the fluids stored in their respective tanks 106, 108 into combination with water from the central tank 104 to be provided to a turbine engine. Thus, conduits may extend into the left and right tanks 106, 108 that allow the pumps to withdraw the fluids therein. Those having skill in the art will appreciate that other types of pumps may also beneficially be used for this purpose. Each of the right and left pumps 128, 130 may have different pump capabilities, such as, for example, different flow rates, power requirements, sizes, and other related properties. For example, a pump configured to inject gas path cleaner solution that is provided to the wash line may have a higher output flow rate than a pump configured to inject isopropyl alcohol that is provided to the wash line since a dilution ratio of isopropyl alcohol in the wash line is typically significantly smaller than the dilution ratio of gas path cleaner solution. The connection within the control unit 102 between the output of the pumps 128, 130 and the main pump 132 that draws water from the central tank 104 is shown and described in greater detail in connection with FIGS. 3A-3C and 4.

Three gauges 134, 136, 138 may be positioned at the front of the control unit 102 to indicate fill levels of the tanks 104, 106, 108. As shown in FIG. 2, the front of the tanks 104, 106, 108 is cut away to view the positions of level gauges 200, 202, 204 that extend downward into the tanks 104, 106, 108 to determine the fill levels of the tanks 104, 106, 108 for easier external reference of the operator.

FIGS. 3A-3C show views of the control unit 102. FIG. 3A shows detail of the front of the control unit 102, FIG. 3B shows a right isometric view of the internal components of the control unit 102, and FIG. 3C shows a left isometric view of the internal components of the control unit 102. In FIGS. 3B and 3C, wiring and hoses are not shown to prevent occluding visibility of other internal components.

In FIG. 3A, the right pump 128 and left pump 130 are shown adjacent to a right control feature 300 and a left control feature 302, respectively. The right and left control features 300, 302 may comprise one or more knobs or switches for operating the peristaltic right and left pumps 128, 130, respectively. Thus, by adjustment of the right control feature 300, the user may adjust the pump rate of the right pump 128, and the rate of the left pump 130 may be changed by adjustment of the left control feature 302. In some embodiments, these adjustments may be made while one or more of the pumps 128, 130, 132 are operated, such as during a washing or rinsing cycle.

The front of the control unit 102 may also comprise a power receptacle 304. The power receptacle 304 may be a connection point for a power supply to connect to and provide power to the control unit 102 and the electronics it bears. An output coupling 306 is positioned on the panel of the control unit 102 that has the power receptacle 304. The output coupling 306 is configured to provide combined flow from the pumps 128, 130, 132 to a wash line or hose connected to the output coupling 306. The output coupling 306, like the central coupler 126, may be a quick-disconnect type coupling for ease of connection and disconnection of hose and other apparatus.

A control button 308 may be positioned in the control unit 102 near the output coupling 306. The control button 308 may be used as a power switch for the control unit 102 to turn on or off the system 100. An indicator 310 may also be positioned on the front of the control unit 102 and may be used to indicate faults or other status information about the control unit 102 and electronics therein. In one example, the indicator 310 may light when the central tank 104 is empty or the internal battery 320 is discharged.

The control unit 102 may also comprise float switches 312, 314 that extend into the central tank 104. See FIGS. 3B-3C. A lower float switch 312 may sense when the supply of fluid in the central tank 104 falls below a predetermined lower value, and an upper float switch 314 may sense when the supply of fluid fills up to a predetermined upper value. Thus, the lower float switch 312 may be used to shut off the pumps 128, 130, 132 when the central tank 104 is empty or low on fluid. The upper float switch 314 may be used to shut off a fill valve 402 when the central tank 104 is full, thereby preventing overfilling of the central tank 104 through the central coupler 126.

FIG. 3B also shows the internal features of the left and right control features 300, 302. These control features 300, 302 may be PWM controllers or other pump controllers configured to adjust the outputs of the left and right pumps 106, 108 as they are provided to the flow out through the output coupling 306. Thus, the output of each pump 106, 108 may be increased or decreased by use of the control features 300, 302, such as by turning knobs extending through the external housing of the control unit 102.

A pressure gauge 316 may also be positioned on the control unit 102. The pressure gauge 316 may provide a readout of the pressure provided to the output coupling 306. Some users may desire confirmation that a predetermined pressure level is provided by the wash system 100, so the gauge 316 may be used to ensure that the preferred pressure level is being generated.

FIGS. 3B-3C show a battery charger 318 within the housing of the control unit 102 that may be used to charge a battery 320 (see FIG. 3C). Thus, when the power receptacle 304 is connected to a power source, the receptacle 304 may relay power to the battery charger 318 which drives current into the battery 320. The compact fit of the battery charger 318 and battery 320 within the space of the housing of the control unit 102 may greatly decrease the overall size and weight of the wash system 100 as compared to conventional systems requiring generator devices (e.g., diesel generators with their attendant fuel tanks).

Hoses may connect the output of the left and right pumps 106, 108 to a cross manifold 322 in the control unit 102. The cross manifold 322 may also be linked to the central pump 132 and to the supply of fluid (which is typically water) in the central tank 104. More detail regarding the connections and function of the cross manifold 322 is described in connection with FIG. 4.

As mentioned above, the central coupler 126 may be used as an inlet for filling the central tank 104. FIG. 4 shows an exploded view of the flow system 400 of the present embodiment of the wash system 100. The central coupler 126 is shown linked to an electronic fill valve 402 that may be configured to control flow into an inlet 404 of the central tank 104.

As the wash system 100 is used, the battery 320 may discharge and the central tank 104 may deplete its supply of fluid. Often, users will remember to fill the central tank 104 with water but neglect to recharge the battery 320 after use, so there will be sufficient water to perform a wash operation, but not enough charge in the battery 320 for proper operation. When the state of charge is low enough on the battery 320, insufficient power may be provided to the pumps 128, 130, 132, and the wash system 100 may be sluggish or dysfunctional. The fill valve 402 may be used to prevent this scenario. The fill valve 402 may be an electronic ball valve or other electronic valve that cuts off flow coming through the central coupler 126 into the inlet 404 of the central tank 104 unless the power receptacle 304 is connected to a power source. Thus, if the user provides water to the central coupler 126 without plugging in the system 100, the central tank 104 will not fill with water and it will be immediately apparent to the user that the additional step of charging the battery 320 needs to be taken as well. In some embodiments, a fill valve 402 may be omitted.

Still referring to FIG. 4, the central pump 132 may draw fluid from the central tank 104 through outlet 406 in the central tank 104. The outlet 406 may connect to the cross manifold 322 and into an inlet 408 of the central pump 132. The central pump 132 may then pump the fluid to a T-joint 412 checkpoint from its outlet 410. A pressure regulator 414 is connected to the T-joint 412 that allows runoff of excess pressure through a return line 416. The amount of runoff may be adjustable by control of the pressure regulator 414, such as, for example, by adjustment of control knob 418 on the pressure regulator 414. The runoff in the return line 416 is permitted to recirculate back into the cross manifold 322 to avoid waste.

Flow through the T-joint 412 that does not pass through the pressure regulator 414 exits through a check valve 420. The check valve 420 may be a one-way valve used to prevent backflow from the output coupling 306. Flow exiting the check valve 420 passes to the output coupling 306 for discharge into a connection to the aircraft turbine engine.

An optional pressure switch 422 may be positioned to sense fluid pressure coming out of the check valve 420. The pressure switch 422 may detect when discharge pressure reaches a predetermined level as flow stops coming through the output coupling 306 and may then be used to switch off the pumps 128, 130, 132. Additionally, as water in the central tank 104 reaches depletion, the level switch in the central tank 104 stops the pumps 128, 130, 132 when the level of the central tank 104 is too low. The line leading to the pressure switch 422 may also be used to provide a reading to the pressure gauge 316.

Flow may be received from the left tank 106 and right tank 108 via their respective left pump 130 and right pump 128. As shown in FIG. 4, output of the right pump 128 and left pump 130 may be directed into the cross manifold 322. The cross manifold 322 may therefore act as a mixing vessel within which a mixing chamber facilitates the mixing of the fluids of two or more of the tanks 104, 106, 108 as the fluids are drawn into the cross manifold 322 and subsequently into the central pump 132 through line 426.

Flow from the left pump 130 may be directed into a combining manifold 424 which may also receive the return line 416 from the pressure regulator 414. The combining manifold 424 may be referred to as being a second mixing vessel having within it a second mixing chamber. During a wash portion of an engine wash cycle, gas path cleaner solution may be added from the left pump 130 to the flow of water from the central tank 104 into the central pump 132, and during a rinse portion, the gas path cleaner solution may be cut off from the central pump 132. During one or more of the wash and rinse portions, alcohol solution may be introduced into the flow from the line leading from the right pump 128.

As used herein, a “wash line” may refer to a line through which water of the wash or rinse fluid is directed. For example, as shown in FIG. 4, a wash line may include line 428. A wash line may alternatively include a line or hose externally connected to output coupling 306 that is directed to the aircraft turbine engine or connected to a wash wand and nozzle that can spray fluid into the engine or rinse fluid off of the fuselage of an aircraft.

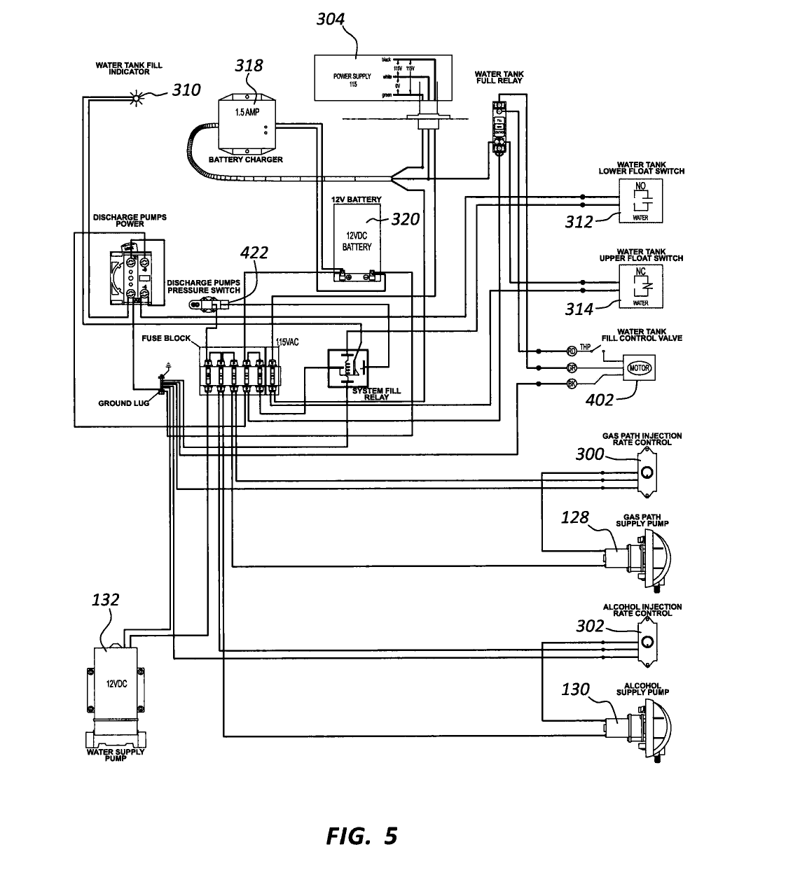

FIG. 5 is an electrical diagram illustrating connections between various portions of the electronic features of the wash system 100. The left pump 128, right pump 130 central pump 132, the right control feature 300, left control feature 302, power supply (via power receptacle 304), indicator 310, lower float switch 312, upper float switch 314, battery charger 318, battery 320, and fill valve 402 may all be interconnected to control operation of the wash system 100. The right control feature 300, left control feature 302, control button 308, indicator 310, lower float switch 312, upper float switch 314, battery charger 318, battery 320, and fill valve 402 may collectively be referred to as a controller unit or controller apparatus of the system. Other sensors and control features such as the pressure switch 422 and the pressure regulator 414 may also be part of the controller unit or controller apparatus.

Thus, the controller unit or controller apparatus may be operated to adjustably control a solution dilution ratio of the solutions pumped by the left and right pumps 128, 130 into the wash line of the system. For example, the right and left control features 300, 302 may adjust the output rates of the pumps 128, 130 as they supply fluids diluted into water from the central tank 104. In at least one embodiment, one or both of the control features 300, 302 may be operated to turn down a dilution ratio of one of the fluids being supplied to the wash line to a zero value, such as by turning off one of the pumps 128, 130 as the central pump 132 is still operated. Thus, water pumped by the central pump 132 may flow in the wash line independent of solution output from either of the left or right pumps 128, 130.

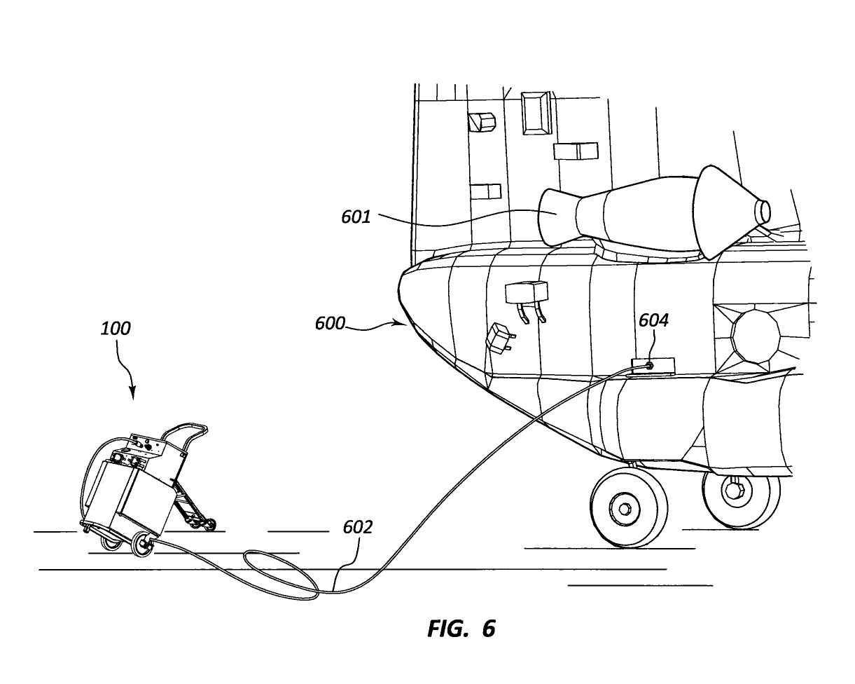

FIG. 6 shows an example application of the wash system 100 wherein it is connected to an aircraft 600 having a turbine engine 601 by a wash line 602. The aircraft turbine engine 601 may include a wash port 604 onto which the wash line 602 is connected. In some embodiments, the wash port 604 receives both the wash fluid (e.g., water plus diluted gas path cleaner agent) and rinse fluid (e.g., water without diluted cleaner agent). The wash port 604 may therefore connect the wash line 602 to gas path cleaning passages in the turbine engine 601 of the aircraft 600. In some embodiments, the wash port 604 may direct wash fluid and rinse fluid directly into contact with turbine blades and other surfaces within the turbine engine 601 that can be cleaned using a diluted gas path cleaner and/or alcohol solution.

In FIG. 6, the aircraft 600 is shown as a rotary wing aircraft having a turbine engine 601. In other embodiments, other types of turbine engines may be cleaned using the wash system 100, such as, for example, turbine engines of fixed-wing aircraft and other turbine-powered vehicles. Rotary wing aircraft may benefit from the wash system 100 over conventional wash systems at least because rotary wing aircraft are often used in areas with tighter constraints on storage facilities and space on a launch pad or runway. The compact size and simplicity of the wash system 100 may therefore allow easier and more convenient washing of turbine engines in these smaller installations. The wash line 602 shown in FIG. 6 may be a hose having connection elements at each of its terminal ends. Therefore, a first end of the wash line 602 may have a quick-disconnect connector to link to the output coupling 306 of the wash system 100, and a second end of the line may have a connector used to link to the wash port 604 of the aircraft 600.

The wash line 602 may alternatively be connected to a spray gun, nozzle, probe, or other fluid delivery device that may be used to direct fluids into or onto the turbine engine 601. For example, spray gun 120 may be connected to the wash line 602, and fluids from the wash line may be directed through its wand and adjustable nozzle when a trigger on the gun 120 is operated.

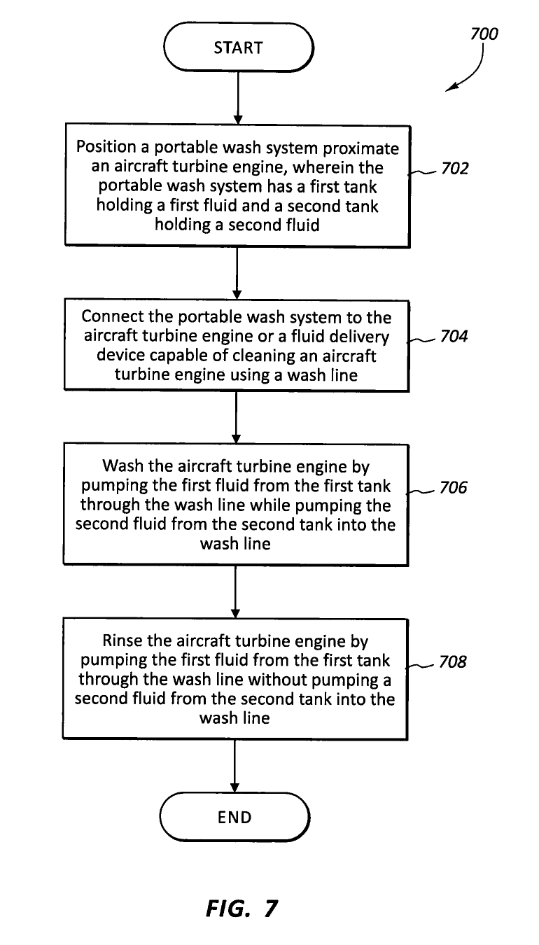

FIG. 7 is a flowchart illustrating an example embodiment of a method 700 of the present disclosure. The method 700 may begin with a step wherein a portable wash system may be positioned proximate an aircraft turbine engine, as shown in block 702. Positioning the system proximate an engine may comprise moving the portable wash system to a position near the engine that is near enough to allow a hose or wash line to connect the wash system to the engine or to allow a sprayer or probe to provide fluids to the engine (as indicated by block 704).

The portable wash system may have a first tank holding a first fluid and a second tank holding a second fluid. The first and second fluids may be different fluids, such as the first fluid being water (e.g., distilled or soft water) and the second fluid being an engine gas path cleaning agent. The first tank may have a larger capacity than the second tank or may have a larger volume of fluid drawn from it than the second tank. The first fluid may also be pumped from the first tank for a longer period of time than the second fluid may be pumped from the second tank. The second fluid may be concentrated such that it can be diluted into the first fluid upon delivery to a gas path of an engine.

Block 704 indicates that the portable wash system may be connected to an aircraft turbine engine or a fluid delivery device capable of cleaning an aircraft turbine engine using a wash line. The wash line may be a hose or other connective device configured to pass fluid pumped from the first and second tanks into the gas path of an engine. Connecting the wash line may comprise connecting the end of the wash line to a cleaning valve or nozzle on the engine that leads to the gas path of the engine. Connecting the wash line may also comprise attaching it to a spray gun, nozzle, probe, or other fluid delivery device that can direct cleaning fluids into or onto the engine.

In block 706, the engine is washed by pumping the first fluid from the first tank through the wash line while pumping the second fluid from the second tank into the wash line. In some embodiments, the first and second fluids are combined and intermixed in this step. With the second fluid embodied as a gas path cleaner agent and the first fluid embodied as water, the combination may be used to dissolve and clean away deposits in the gas path of the engine. Simultaneously, an aircraft operator may spool the turbine engine to facilitate circulation of the combined first and second fluids throughout the areas to be cleaned in the gas path. In some embodiments, the first and second fluids may be mixed in a mixing chamber or manifold in the wash system.

In other embodiments, each fluid may be added to the wash line separately, wherein the fluids mix with each other in the wash line rather than at a specific chamber, manifold, or junction in the wash system. The fluids may also be mixed before being pumped into the wash line. In additional embodiments, a third fluid may be introduced into the wash line while the engine is being washed, such as, for example, an alcohol or other antifreeze agent. The third fluid may be stored in a third tank provided with the wash system. In yet another embodiment, block 706 may further comprise controlling a dilution ratio of the second fluid relative to the first fluid while washing the aircraft turbine engine. The dilution ratio may be controlled by controlling output settings of a pump (e.g., peristaltic pump) used to feed the second fluid into the first fluid or into the wash line. While the pumps are active, the pressure in the wash line may be automatically controlled using a pressure regulator. The pressure regulator may recirculate excess flow to avoid waste.

In block 708, the turbine engine is rinsed by pumping the first fluid from the first tank through the wash line without pumping a second fluid from the second tank into the wash line. Thus, the second fluid may not be pumped during the rinse operation, but fluid from the first tank may be provided. In some embodiments, a third fluid from a third tank may be provided along with the first fluid in block 708. For instance, a third fluid comprising an antifreeze agent may be provided with a first fluid comprising water in order to keep the water from freezing in the wash line or in the gas path of the engine. The engines may also be spooled during the execution of block 708.

Additional steps may comprise disconnecting the wash line from the engine, connecting an electrical power source to the wash system to recharge a battery system provided with the wash system, and connecting a source of the first fluid (e.g., a water source) to the wash system to refill the first tank. In some embodiments, the source of the first fluid may be prevented from filling the first tank unless the power source is connected to the wash system to recharge the battery, such as is described above in connection with fill valve 402.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A portable aircraft turbine engine washing system, comprising:
a portable base unit;
a wash line connectable to the portable base unit and configured to be connected to an aircraft turbine engine or a fluid delivery device capable of cleaning an aircraft turbine engine;
a water tank movable with the portable base unit and configured to hold water;
a water pump apparatus movable with the portable base unit and configured to pump water out of the water tank and into the wash line;
a solution tank movable with the portable base unit and configured to hold a solution;
a solution pump apparatus movable with the portable base unit and configured to pump solution from the solution tank into fluid communication with the wash line;
a controller apparatus configured to adjustably control a dilution ratio of the solution pumped by the solution pump apparatus with water pumped into the wash line from the water tank while the solution and water are pumped into the wash line.

2. The system of claim 1, further comprising an alcohol solution held in the solution tank.

3. The system of claim 1, further comprising a turbine deposit dissolving agent held in the solution tank.

4. The system of claim 1, further comprising a mixing vessel in fluid communication with the wash line, wherein the mixing vessel comprises a chamber configured to receive and mix output of the water tank and output of the solution tank.

5. The system of claim 1, wherein the solution pump apparatus is a peristaltic pump.

6. The system of claim 1, wherein the portable base unit comprises a wheeled cart.

7. The system of claim 1, wherein the portable base unit has a height of about 5 feet or less.

8. The system of claim 1, wherein the portable base unit has a width of about 3 feet or less.

9. The system of claim 1, wherein the water tank has a capacity of about 20 gallons or less.

10. The system of claim 1, wherein water output from the water pump apparatus is configurable to flow in the wash line independent of solution output from the solution pump apparatus.

11. The system of claim 1, wherein the controller apparatus is configurable to control the dilution ratio of the solution pumped by the solution pump apparatus into the wash line to a zero value.

12. The system of claim 1, wherein the wash line is configured to be connected to a gas path of the aircraft turbine engine.

13. The system of claim 1, further comprising an electrical energy storage device, wherein the water pump apparatus and the solution pump apparatus are electrically powered by the energy storage device.

14. A portable aircraft turbine engine washing system, comprising:
a portable base unit;
a wash line connectable to the portable base unit and configured to be connected to an aircraft turbine engine or a fluid delivery device capable of cleaning an aircraft turbine engine;
a water tank movable with the portable base unit and configured to hold water;
a water pump apparatus movable with the portable base unit and configured to pump water out of the water tank and into the wash line;
a solution tank movable with the portable base unit and configured to hold a solution;
a solution pump apparatus movable with the portable base unit and configured to pump solution from the solution tank into fluid communication with the wash line;
a component tank movable with the portable base unit and configured to hold a fluid component to be provided to the aircraft turbine engine;
a component pump apparatus configured to pump the fluid component from the component tank into fluid communication with the wash line;
a controller apparatus configured to adjustably control a solution dilution ratio of the solution pumped by the solution pump apparatus into fluid communication with the wash line while water is pumped into the wash line from the water tank, and the controller apparatus being configured to adjustably control a component dilution ratio of the fluid component pumped by the component pump apparatus into fluid communication with the wash line while water is pumped into the wash line from the water tank.

15. The system of claim 14, further comprising the fluid component and the solution, wherein the fluid component is an alcohol solution and the solution is a turbine engine deposit cleaning agent.

16. The system of claim 14, wherein the component pump apparatus and the solution pump apparatus are configured to provide fluid component and solution into the wash line simultaneously.

17. The system of claim 14, further comprising a mixing vessel in fluid communication with the wash line, wherein the mixing vessel comprises a chamber configured to receive and mix water output from the water tank, solution output from the solution tank, and fluid component output from the component tank.

18. The system of claim 14, further comprising a first mixing vessel and a second mixing vessel, the first and second mixing vessels being in fluid communication with the wash line, wherein the first mixing vessel comprises a first chamber configured to receive and mix water output from the water tank and solution output from the solution tank, wherein the second mixing vessel comprises a second chamber configured to receive and mix water output from the water tank and fluid component output from the component tank.

19. A method of washing an aircraft turbine engine, the method comprising:
positioning a portable wash system proximate an aircraft turbine engine, the portable wash system having a first tank holding a first fluid and a second tank holding a second fluid;
connecting the portable wash system to the aircraft turbine engine or a fluid delivery device capable of cleaning an aircraft turbine engine using a wash line;
washing the aircraft turbine engine by pumping the first fluid from the first tank through the wash line while pumping the second fluid from the second tank into the wash line;
rinsing the aircraft turbine engine by pumping the first fluid from the first tank through the wash line without pumping a second fluid from the second tank into the wash line.

20. The method of claim 19, wherein a gas path of the aircraft turbine engine is washed or rinsed using the first and second fluids.

21. The method of claim 19, wherein the first and second fluids are mixed before pumping into the wash line for washing the aircraft turbine engine.

22. The method of claim 19, wherein the portable wash system is provided with a third tank holding a third fluid.

23. The method of claim 22, wherein the third fluid is pumped from the third tank through the wash line while washing the aircraft turbine engine.

24. The method of claim 22, wherein the third fluid is pumped from the third tank through the wash line while rinsing the aircraft turbine engine.

25. The method of claim 19, further comprising controlling a dilution ratio of the second fluid relative to the first fluid while washing the aircraft turbine engine.

26. The method of claim 19, wherein the pressure in the wash line is controlled automatically using a pressure regulator.

27. The method of claim 19, wherein the second fluid inhibits freezing of the first fluid when pumped through the wash line.

28. The method of claim 19, wherein the second fluid facilitates removal of impurities in the aircraft turbine engine when provided to the aircraft turbine engine.
